(19) United States
(12) Patent Application Publication
(10) Pub. No.: US 2025/0256620 A1
(43) Pub. Date: Aug. 14, 2025

(54) SYSTEMS AND METHODS FOR BALANCING STATE OF CHARGES OF BATTERY MODULES

(71) Applicant: GM GLOBAL TECHNOLOGY OPERATIONS LLC, Detroit, MI (US)

(72) Inventors: Lei HAO, Troy, MI (US); Derek Frei Lahr, Ann Arbor, MI (US); Mohamed Kamel, Birmingham, MI (US); Insu Chang, Troy, MI (US); Xiaoling Chen, Sterling Heights, MI (US); Chengwu Duan, Shanghai (CN)

(21) Appl. No.: 18/598,174

(22) Filed: Mar. 7, 2024

(30) Foreign Application Priority Data
Feb. 8, 2024 (CN) 202410176928.9

(51) Int. Cl. B60L 58/22; B60L 58/20; H02J 7/00; H02J 7/34

(52) U.S. Cl. CPC B60L 58/22; B60L 58/20; H02J 7/0016; H02J 7/00714; H02J 7/007182; H02J 7/342; B60L 2210/10; H02J 2207/20

(57) ABSTRACT

A system for a vehicle includes a first battery module having a first capacity, a second battery module having a second capacity different than the first capacity, a DC-DC converter coupled to the first battery module and the second battery module, and a control module coupled to the DC-DC converter. The control module is configured to sense a first parameter associated with the first battery module and a second parameter associated with the second battery module, and control the DC-DC converter based on the first parameter and the second parameter to balance a state of charge of the first battery module and a state of charge of the second battery module. Other example systems and methods for controlling DC-DC converters to balance state of charges of battery modules are also disclosed.

### CROSS-REFERENCE TO RELATED APPLICATIONS

This application claims the benefit of Chinese Patent Application No. 202410176928.9, filed on Feb. 8, 2024. The entire disclosure of the application referenced above is incorporated herein by reference.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates to systems and methods for balancing state of changes of battery modules.

Electric vehicles (EVs) such as battery electric vehicles (BEVs), hybrid vehicles, and/or fuel cell vehicles include one or more electric machines and a battery system including one or more battery cells. The battery cells can be arranged in battery modules including two or more battery cells and/or in battery packs including two or more battery modules. A power control system is used to control charging and/or discharging of the battery system from a utility, regenerative braking and/or acceleration during driving.

### SUMMARY

A system for a vehicle includes a first battery module having a first capacity, a second battery module having a second capacity different than the first capacity, a DC-DC converter coupled to the first battery module and the second battery module, and a control module coupled to the DC-DC converter. The control module is configured to sense a first parameter associated with the first battery module and a second parameter associated with the second battery module, and control the DC-DC converter based on the first parameter and the second parameter to balance a state of charge of the first battery module and a state of charge of the second battery module.

In other features, the DC-DC converter includes a first power switch coupled in parallel with the first battery module, a second power switch coupled in parallel with the second battery module, and an inductor coupled between the first and second power switches and the first and second battery modules.

In other features, the control module is configured to sense a current flowing through the inductor, and control the DC-DC converter based on the sensed current, the first parameter and the second parameter to balance the state of charge of the first battery module and the state of charge of the second battery module.

In other features, the control module is configured to control a current flowing through the inductor to balance the state of charge of the first battery module and the state of charge of the second battery module.

In other features, the first capacity of the first battery module is greater than the second capacity of the second battery module.

In other features, the control module is configured to control the first power switch with a pulse width modulated control signal to discharge current from the first battery module to the second battery module via the inductor, when the control module is in a discharging mode in which the first battery module and the second battery module provide power a load.

In other features, the control module is configured to control the second power switch with a pulse width modulated control signal to discharge current from the second battery module to the first battery module via the inductor, when the control module is in a charging mode in which the first battery module and the second battery module are receiving power.

In other features, the DC-DC converter includes a first capacitor coupled in parallel with the first power switch, and a second capacitor coupled in parallel with the second power switch.

In other features, the first parameter is a voltage of the first battery module, and the second parameter is a voltage of the second battery module.

In other features, the first battery module includes a plurality of cells, the second battery module includes a plurality of cells, and a chemical composition of at least one cell of the first battery module is different than a chemical composition of at least one cell of the second battery module.

In other features, the at least one cell of the first battery module is a lithium-nickel-cobalt-manganese oxide (NMC) cell, and the at least one cell of the second battery module is a lithium ferrophosphate (LFP) cell.

In other features, the first battery module includes N cells, the second battery module includes M cells, and N and M are integers greater than zero, and N is different than M.

In other features, the first battery module includes a plurality of cells, the second battery module includes a plurality of cells, and at least one dimension of the first battery module is different than a corresponding dimension of the second battery module.

In other features, a vehicle comprising the system and at least one load coupled to the first battery module and the second battery module.

A method of controlling a DC-DC converter in a vehicle to balance a state of charge of a first battery module and a state of charge of a second battery module is disclosed. The DC-DC converter includes a first power switch coupled in parallel with the first battery module, a second power switch coupled in parallel with the second battery module, and an inductor coupled between the first and second power switches and the first and second battery modules. The first battery module has a first capacity, the second battery module has a second capacity different than the first capacity. The method includes sensing at least one first parameter associated with the first battery module and at least one second parameter associated with the second battery module, and controlling the first power switch or the second power switch based on the first parameter and the second parameter to balance the state of charge of the first battery module and the state of charge of the second battery module.

In other features, the first capacity of the first battery module is greater than the second capacity of the second battery module.

In other features, controlling the first power switch or the second power switch includes controlling the first power switch with a pulse width modulated control signal to discharge current from the first battery module to the second battery module via the inductor, when the first battery module and the second battery module are providing power a load.

In other features, controlling the first power switch or the second power switch includes controlling the second power switch with a pulse width modulated control signal to discharge current from the second battery module to the first battery module via the inductor, when the first battery module and the second battery module are receiving power.

In other features, the first battery module includes a plurality of cells, the second battery module includes a plurality of cells, and a chemical composition of at least one cell of the first battery module is different than a chemical composition of at least one cell of the second battery module.

In other features, the at least one cell of the first battery module is a lithium-nickel-cobalt-manganese oxide (NMC) cell, and the at least one cell of the second battery module is a lithium ferrophosphate (LFP) cell.

In other features, the first battery module includes N cells, the second battery module includes M cells, and N and M are integers greater than zero, and N is different than M.

In other features, the first battery module includes a plurality of cells, the second battery module includes a plurality of cells, and at least one dimension of the first battery module is different than a corresponding dimension of the second battery module.

Further areas of applicability of the present disclosure will become apparent from the detailed description, the claims and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a block circuit diagram of an example power system for balancing state of charges of two battery modules having different capacities, according to the present disclosure;

FIG. 2 is an isometric view of a battery pack including multiple battery modules according to the present disclosure;

FIG. 3 is a side view of the battery pack of FIG. 2;

FIG. 4 is a block circuit diagram of an example power system for balancing state of charges of two battery modules having different chemical compositions, according to the present disclosure;

FIG. 5 is a block circuit diagram of the power system of FIG. 1 including a control module, according to the present disclosure;

FIGS. 6-7 are block circuit diagrams of the power system of FIG. 1 showing current flow during a discharging mode, according to the present disclosure;

FIG. 8 shows graphs representing various current characteristics and control signals for the power system 100 of FIGS. 6-7, according to the present disclosure;

FIGS. 9-10 are block circuit diagrams of the power system of FIG. 1 showing current flow during a charging mode, according to the present disclosure;

FIG. 11 shows graphs representing various current characteristics and control signals for the power system 100 of FIGS. 9-10, according to the present disclosure;

FIG. 12 is a block circuit diagram of the control module of FIG. 5, according to the present disclosure;

FIG. 13 shows graphs representing various current characteristics of the power system 100 of FIG. 1 during a discharging mode, according to the present disclosure;

FIG. 14 shows graphs representing various current characteristics of the power system 100 of FIG. 1 during a charging mode, according to the present disclosure;

FIG. 15 is a vehicle including a power system for balancing state of charges of two battery modules, according to the present disclosure; and

FIG. 16 is flowchart of an example control process for balancing state of charges of two battery modules, according to the present disclosure.

In the drawings, reference numbers may be reused to identify similar and/or identical elements.

### DETAILED DESCRIPTION

A battery pack for an EV includes battery modules each having battery cells. The battery pack is often designed to maximize energy associated with a rechargeable energy storage system (RESS) in the EV and to maximize available space in the EV. To do so, battery cells having different dimensions, chemical compositions, and/or capacities may be packed together into different regions to form the battery modules, and then the battery modules may be grouped together to form the battery pack. Due to the differing configurations of battery cells, some of the battery modules may have different capacities. This may result in unbalanced power usage and state of charges for the battery modules. In other words, the amount of energy (e.g., a percentage) available in each battery module at a given time may be different.

The power systems and methods according to the present disclosure utilize a unique DC-DC power converter to balance the state of charges of battery modules having different capacities and/or chemical compositions. In various embodiments, the unique DC-DC power converter includes an inductor and two power switches controlled to transfer current from one of the battery modules to another one of the battery modules via the inductor. In doing so, the amount of current transferred (e.g., passing through the inductor) may be controlled to balance the state of charges of the battery modules having different capacities and/or chemical compositions. As a result, a RESS may be designed with battery modules having different capacities and dimensions to maximize the usage of available space in the EV, while also meeting load demands in the EV.

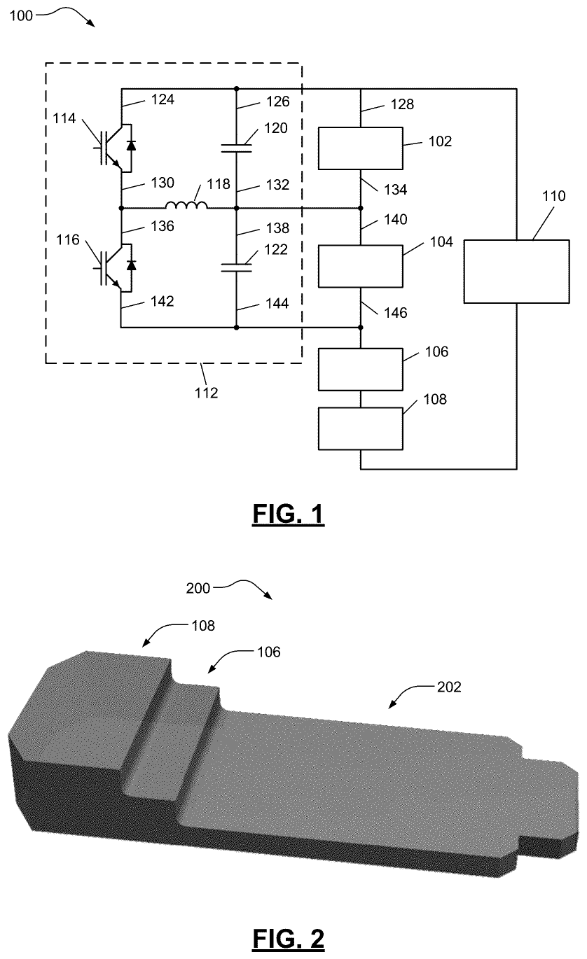

Referring now to FIG. 1, a schematic diagram of an example power system 100 for a RESS is presented. As shown in FIG. 1, the power system 100 generally includes four battery modules 102, 104, 106, 108 coupled to one or more components 110, and a DC-DC converter 112 coupled to the battery modules 102, 104. In such examples, the component(s) 110 may represent one or more loads or charging sources (e.g., a utility and/or another external power source, regenerative braking and/or another internal power source, etc.) depending on whether the battery modules 102, 104, 106, 108 are being discharged to power the load(s) or being charged from the charging source(s). Additionally, in the example of FIG. 1, the battery modules 102, 104 have different capacities. For example, in FIG. 1, the battery module 102 has the highest capacity, the battery module 104 has the lowest capacity, and the battery modules 106, 108 have the same capacities (e.g., depending on the design of the battery modules 102, 104).

Although the power system 100 is shown as including four battery modules, it should be appreciated that the power system 100 (and/or any other power system herein) may include more or less battery modules. Additionally, while not shown in FIG. 1, the power system 100 includes a control module for controlling the DC-DC converter 112 based on sensed parameters to balance a state of charge (SOC) of the battery module 102 and a SOC of the battery module 104.

In FIG. 1, the DC-DC converter 112 is generally used for SOC balancing of the battery modules 102, 104, as further explained herein. In such examples, the DC-DC converter 112 does not provide power to or receive power from any component besides the battery modules 102, 104. For instance, the DC-DC converter 112 does not provide power to or receive power from the component(s) 110 (e.g., when functioning as a load or a charging source). As such, a rating of the DC-DC converter 112 may be determined solely by the SOC balancing requirements of the battery modules 102, 104 over a drive cycle. For instance, the converter voltage may be determined based on a maximum voltage of the two connected battery modules 102, 104 with different capacities. Additionally, the converter current may be determined based on a maximum balancing current over a drive cycle. For example, for an 800V/275 Ah battery pack including the battery modules 102, 104, 106, 108, the converter rating may be only 3 kW with a voltage rating of 200V and a current rating of 15A.

As shown in FIG. 1, the DC-DC converter 112 includes two power switches 114, 116, an inductor 118, and optional capacitors 120, 122. In such examples, the capacitors 120, 122 may function to filter ripple current generated by the inductor 118. In various embodiments, the power switches 114, 116 may be any suitable switching devices, such as bipolar transistors (e.g., insulated-gate bipolar transistors, etc.), field-effect transistors (e.g., metal-oxide-semiconductor field-effect transistors, etc.), wide-bandgap (WBG) switching devices, etc.

In this example, the power switches 114, 116 are coupled in parallel with the battery modules 102, 104 and the optional capacitors 120, 122, respectively. As such, the power switches 114, 116 are coupled in parallel with the battery modules 102, 104 having different capacities (e.g., the capacity of the battery module 102 is greater than the capacity of the battery module 104).

Additionally, the inductor 118 and the capacitors 120, 122 are coupled between the power switches 114, 116 and the battery modules 102, 104. More specifically, the power switch 114 includes opposing terminals 124, 130, the capacitor 120 includes opposing terminals 126, 132, and the battery module 102 includes opposing terminals 128, 134. In this example, the terminals 124, 126, 128 of the power switch 114, the capacitor 120, and the battery module 102 are coupled together, and the terminals 132, 134 of the capacitor 120 and the battery module 102 are coupled together. Similarly, the power switch 116 includes opposing terminals 136, 142, the capacitor 122 includes opposing terminals 138, 144, and the battery module 104 includes opposing terminals 140, 146. As shown, the terminals 130, 136 of the power switches 114, 116 are coupled together, the terminals 132, 138 of the capacitors 120, 122 are coupled together, and the terminals 134, 140 of the battery modules 102, 104 are coupled together. Additionally, the terminals 138, 140 of the capacitor 122 and the battery module 104 are coupled together, and the terminals 142, 144, 146 of the power switch 116, the capacitor 122, and the battery module 104 are coupled together. In the example of FIG. 1, the inductor 118 is coupled between the terminals 130, 136 of the power switches 114, 116, and the terminals 134, 140 of the battery modules 102, 104 (and the terminals 132, 138 of the capacitors 120, 122).

In various embodiments, the battery modules 102, 104, 106, 108 may form a battery pack. In such examples, each battery module 102, 104, 106, 108 may include battery cells. In some examples, some or all of the battery modules 102, 104, 106, 108 may have a different number of cells. For example, the battery module 102 may have N cells and the battery module 104 may have M cells, where N and M are different integers greater than zero. Further, in some examples, some or all of the battery modules 102, 104, 106, 108 may have different dimensions. For instance, the height of the battery module 102 may be different than the height of the battery module 104.

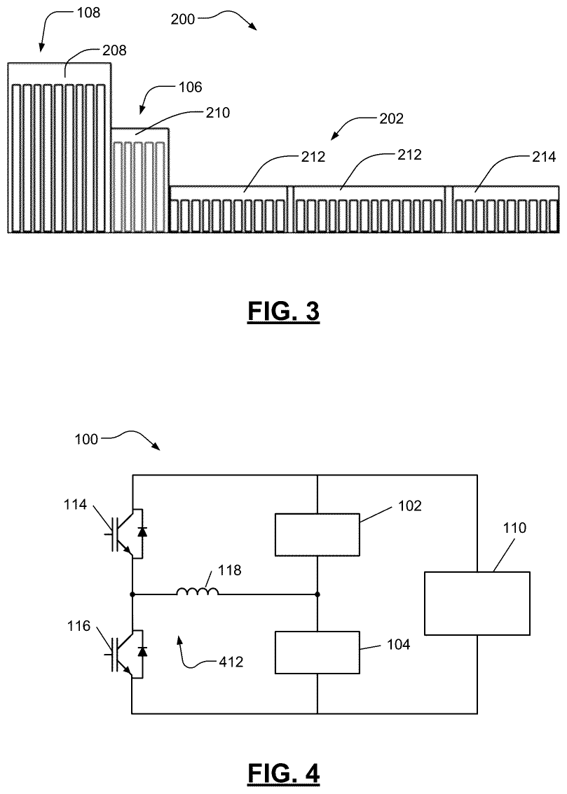

For example, FIGS. 2-3 depict one example configuration of a battery pack 200 including the battery modules 102, 104, 106, 108. In the example of FIGS. 2-3, the battery pack 200 may be referred to as a RESS battery pack, and the battery modules 102, 104 are collectively shown as a battery module 202.

In various embodiments, a cell configuration tool may be utilized to maximize energy of the battery pack 200 with multiple form factor cells. For example, and as shown in FIGS. 2-3, the battery pack 200 includes three layers (or regions), with different sizes and heights. In such examples, the three layers with multiple heights are divided and packed with different battery cells to form the battery modules 106, 108, 202. For example, the battery module 108 includes cells 208, the battery module 106 includes cells 210, and the battery module 202 includes cells 212, 214. More specifically, the battery module 102 of FIG. 1 may include the cells 212, and the battery module 104 of FIG. 1 may include the cells 214. In such examples, prismatic cells may be packed with hybrid orientations, such a mixture of left/right and fore/aft cells. If desired, a pixel based 2D tool may be used to achieve a maximum pack volumetric efficiency when forming the battery modules 106, 108, 202 for the battery pack 200.

As shown in FIGS. 2-3, the battery modules 106, 108, 202 have different dimensions. For example, the battery module 108 (e.g., a high domain) has a height of about 425 mm (in the y direction in FIG. 3) and a width of about 600 mm (in the x direction in FIG. 3), the battery module 106 (e.g., an intermediate domain) has a height of about 275 mm (in the y direction) and a width of about 300 mm (in the y direction), and the battery module 202 (e.g., a low domain) has a height of about 125 mm (in the y direction) and a width of about 2100 mm (in the x direction). While specific dimensions and/or characteristics are described for the battery modules 106, 108, 202 and cells therein, it should be appreciated that any one of the battery modules 106, 108, 202 and/or the cells therein may have another suitable height, width, capacity, etc. depending on, for example, load demand requirements, available space, cell characteristics, etc.

In various embodiments, the battery modules 106, 108, 202 may include a different number of cells in different configurations and having different characteristics, as shown in Tables 1 and 2 below. For example, the battery module 108 includes 136 cells each having a specific dimension and a specific capacity (e.g., 137 Ah). The battery module 106 includes 48 cells having different dimensions than the cells of the battery module 108 but the same capacity (e.g., 137 Ah). The battery module 202 (collectively, the battery module 102, 104 of FIG. 1) includes 620 cells each having a specific dimension and a specific capacity (e.g., 36.7 Ah).

TABLE 1

| | Cell Number | Single Cell Capacity (Ah) |
|---|---|---|
| Battery Module 108 | 136 | 137 |
| Battery Module 106 | 48 | 137 |
| Battery Module 202 | 620 | 36.7 |

In Table 2, a defined number of cells of the battery modules are coupled in parallel and then the parallel sets are coupled in series to achieve a desired voltage to meet load demands. For example, and as shown in Table 2, each set of two cells 208 in the battery module 108 are coupled in parallel to obtain 68 parallel pairs of cells. Then, the 68 parallel pairs of cells are coupled in series to obtain about 285.6 V (e.g., 4.2 volts for each parallel pair multiplied by 68 parallel pairs). The cells 210 of the battery module 106 are arranged similarly, but with 24 parallel pairs of cells to obtain about 100.8 V (e.g., 4.2 volts for each parallel pair multiplied by 24 parallel pairs). The cells 214 of the battery module 104 are broken into sets of seven cells coupled in parallel to obtain 44 parallel pairs. Then, the 44 parallel pairs of cells are coupled in series to obtain about 184.8 V (e.g., 4.2 volts for each parallel pair multiplied by 44 parallel pairs). The cells 212 of the battery module 102 are arranged similarly, but with 39 parallel pairs of eight cells to obtain about 163.8 V (e.g., 4.2 volts for each parallel pair multiplied by 39 parallel pairs). As shown, the battery modules 106, 108 have the same capacity of about 274 Ah, the battery module 104 has a capacity of about 259.9 Ah, and the battery module 102 has a capacity of about 293.6 Ah.

TABLE 2

| | Number of | Battery | | Maximum |
|---|---|---|---|---|
| | individual | Module | Number of | Module |
| | cells in | Capacity | Parallel | Voltage |
| | parallel | (Ah) | Pairs | (V) |
| Cells 208 | 2 | 274 | 68 | 285.6 |
| Cells 210 | 2 | 274 | 24 | 100.8 |
| Cells 214 (of | 7 | 256.9 | 44 | 184.8 |
| battery module | | | | |
| 104) | | | | |
| Cells 212 (of | 8 | 293.6 | 39 | 163.8 |
| battery module | | | | |
| 102) | | | | |

With continued reference to FIG. 1, the battery modules 102, 104, 106, 108 may have the same or different chemical compositions. For example, any one of the battery modules 102, 104, 106, 108 (or cells therein) may have a lithium-nickel-cobalt-manganese oxide (NMC) composition, and another one of the battery modules 102, 104, 106, 108 (or cells therein) may have a lithium ferrophosphate (LFP) composition.

For example, FIG. 4 depicts another example power system 400 similar to the power system 100 of FIG. 1. For example, the power system 400 of FIG. 4 includes a DC-DC converter 412 having the power switches 114, 116 coupled in parallel with the battery modules 102, 104, and the inductor 118 coupled between the power switches 114, 116 and the battery modules 102, 104. In the example of FIG. 4, the DC-DC converter 412 does not include the filter capacitors. The battery modules 102, 104 are coupled to the component(s) 110.

In FIG. 4, the battery modules 102, 104 include different chemical compositions. For example, the battery module 102 has a NMC composition while the battery module 104 has a LFP composition. While the battery modules 102, 104 of FIG. 4 are described as having NMC and LFP compositions, it should be appreciated that the battery modules 102, 104 may have any suitable chemical compositions.

In the example of FIG. 4, the power switches 114, 116 of the DC-DC converter 412 can be controlled to balance the SOC of the battery module 102 and the SOC of the battery module 104, as explained herein. This may be particularly useful given the aging behavior differences for NMC and LFP cells. For example, LFP cells of the battery module 104 typically age slower than NMC cells of the battery module 102. In such examples, the battery module 104 may endure more charging/discharging cycles before its state of health (SOH) deteriorates than the battery module 106.

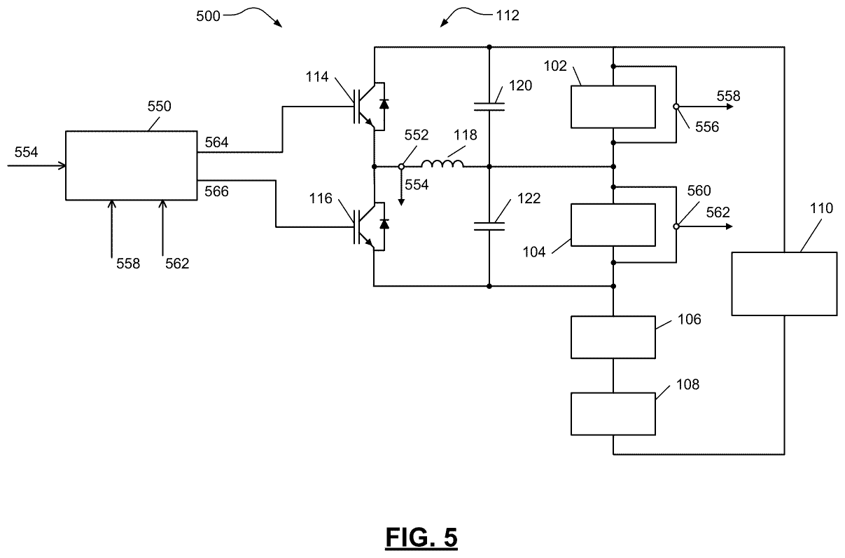

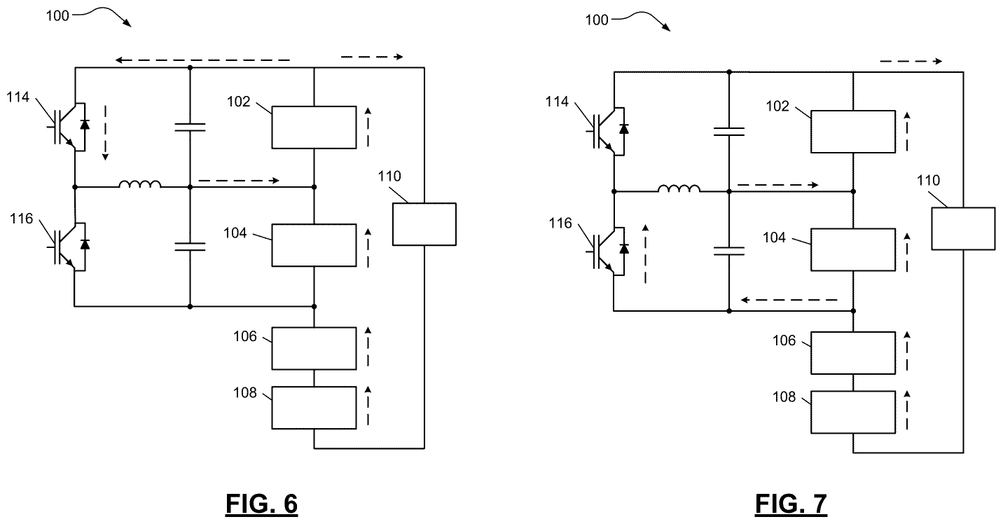

FIG. 5 depicts another example power system 500 similar to the power system 100 of FIG. 1 but including a control module 550 coupled to the DC-DC converter 112. Specifically, the power system 500 includes the DC-DC converter 112 of FIG. 1, the battery modules 102, 104, 106, 108 of FIG. 1, the component(s) 110 of FIG. 1, the control module 550, a current sensor 552, and voltage sensors 556, 560. The DC-DC converter 112 includes the power switches 114, 116, the inductor 118, and the optional capacitors 120, 122 of FIG. 1. Additionally, the battery modules 102, 104 have different capacities, as explained above. For instance, the battery module 102 may have a higher capacity than the battery module 104.

In the example of FIG. 5, the control module 550 senses parameters associated with the battery modules 102, 104 and the inductor 118. For example, the control module 550 senses voltages of the battery modules 102, 104 via the voltage sensors 556, 560, respectively, and a current flowing through the inductor 118 via the current sensor 552. In such examples, the voltage sensors 556, 560 may transmit voltage feedback signals 558, 562 indicative of the sensed voltages to the control module 550, and the current sensor 552 may transmit a current feedback signal 554 indicative of the sensed inductor current to the control module 550.

Then, the control module 550 may control the power switches 114, 116 based on the sensed battery voltage and inductor current to balance the SOC of the battery module 102 and the SOC of the battery module 104. For example, the control module 550 may calculate the SOC of the battery module 102 based on the voltage feedback signal 558 and the SOC of the battery module 104 based on the voltage feedback signal 562. In such examples, the control module 550 may implement conventional methods for calculating the SOCs of the battery modules 102, 104 based on the sensed battery voltages. The control module 550 may then generate control signals (e.g., pulse width modulated (PWM) control signals) 564, 566 for controlling the power switches 114, 116. For example, if the SOCs of the battery modules 102, 104 are unbalanced (e.g., based on a comparison of the calculated SOCs), the control module 550 generates the control signals 564, 566 based on the sensed inductor current to control the amount of current flowing through the inductor 118 to balance the SOCs of the battery modules 102, 104.

For example, the battery modules 102, 104, 106, 108 and the control module 550 may operate in a discharging mode or a charging mode. The discharging mode represents instances when the battery modules 102, 104, 106, 108 provide power to the load, whereas the charging mode represents instances when the battery modules 102, 104, 106, 108 receive power. In some examples, the control module 550 may transition from one mode to the other mode based on current flow. For instance, the control module 550 may detect or sense current flowing towards the battery modules 102, 104, 106, 108 from the component(s) 110 (in this case the charging source(s)) and operate in the charging mode. In other examples, the control module 550 may detect or sense current flowing towards the component(s) 110 (in this case the load(s)) from the battery modules 102, 104, 106, 108 and operate in the discharging mode.

When operating in the discharging mode, the control module 550 may control a duty cycle of the control signal 564 for the power switch 114 to cause current to discharge from the battery module 102 (e.g., the higher capacity battery module) to the battery module 104 (e.g., the lower capacity battery module) via the inductor 118. During this time, the power switch 116 is turned off (e.g., open). With this configuration, the battery module 102 provides additional current to charge the battery module 104, the amount of which is controllable based on the duty cycle. As a result, the battery module 104 provides less current to the load as compared to the battery modules 102, 106, 108, thereby causing the SOC of the battery module 102 to decrease at a faster rate than the SOC of the battery module 104.

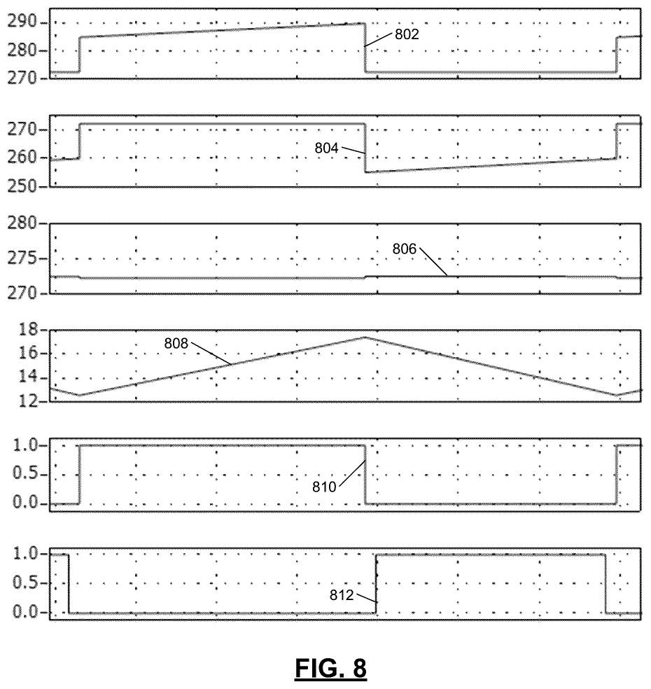

For example, FIGS. 6-7 each depict the power system 100 with the power switches 114, 116 and the battery modules 102, 104, 106, 108. In FIGS. 6-7, the power system 100 is in a discharging mode. During this time, current (represented by the dashed arrowed lines) flows from the battery modules 102, 104, 106, 108 to the component(s) 110 (e.g., a load in this case). In the example of FIG. 6, the power switch 114 is controlled and the power switch 116 is turned off. In the example of FIG. 7, the power switch 114 is turned off and the power switch 116 is controlled. FIG. 8 depicts current 802 of the battery module 102, current 804 of the battery module 104, current 806 of the battery modules 106, 108, inductor current 808, and control signals 810, 812 for the power switches 114, 116, respectively, of FIGS. 6-7.

If, however, the control module 550 is operating in the charging mode, the control module 550 may control a duty cycle of the control signal 566 for the power switch 116 to cause current to discharge from the battery module 104 (e.g., the lower capacity battery module) to the battery module 102 (e.g., the higher capacity battery module) via the inductor 118. During this time, the power switch 114 is turned off (e.g., open). In such examples, the battery module 102 receives additional current from the battery module 104 to charge the battery module 102, the amount of which is controllable based on the duty cycle. As a result, the battery module 104 receives less charging current as compared to the battery modules 102, 106, 108. In turn, this causes the SOC of the battery module 102 to increase at a faster rate than the SOC of the battery module 104.

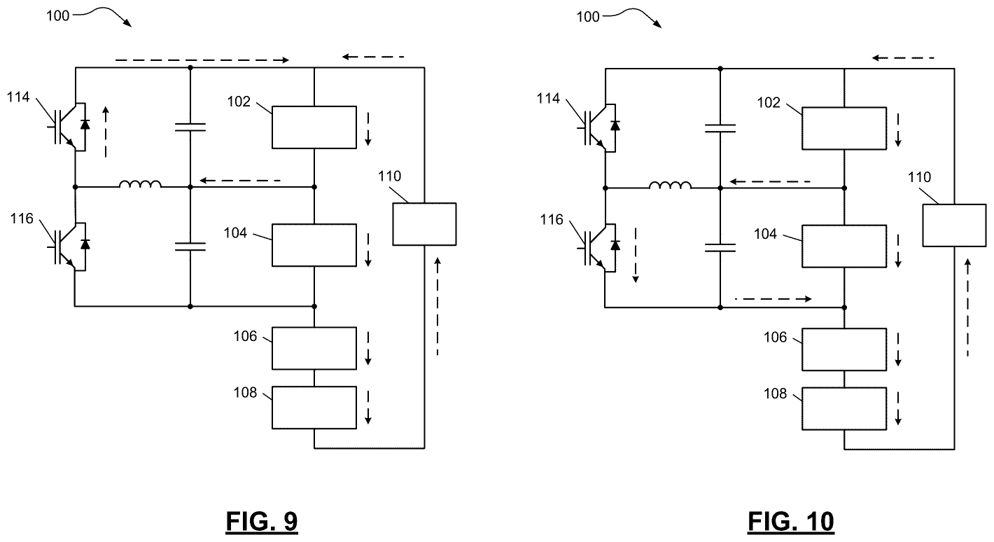

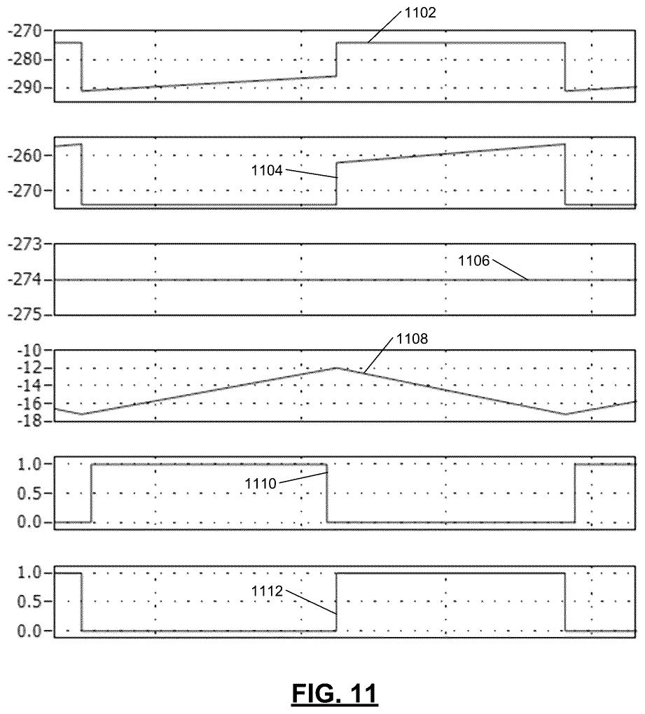

For example, FIGS. 9-10 each depict the power system 100 with the power switches 114, 116 and the battery modules 102, 104, 106, 108. In FIGS. 9-10, the power system 100 is in a charging mode. During this time, current (represented by the dashed arrowed lines) flows from the component(s) 110 (e.g., a charger in this case) to the battery modules 102, 104, 106, 108. In the example of FIG. 9, the power switch 114 is controlled and the power switch 116 is turned off. In the example of FIG. 10, the power switch 114 is turned off and the power switch 116 is controlled. FIG. 11 depicts current 1102 of the battery module 102, current 1104 of the battery module 104, current 1106 of the battery modules 106, 108, inductor current 1108, and control signals 1110, 1112 for the power switches 114, 116, respectively, of FIGS. 9-10.

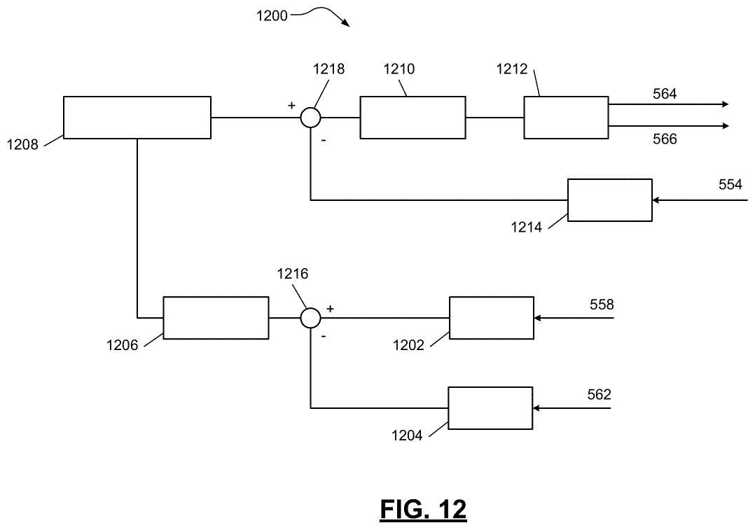

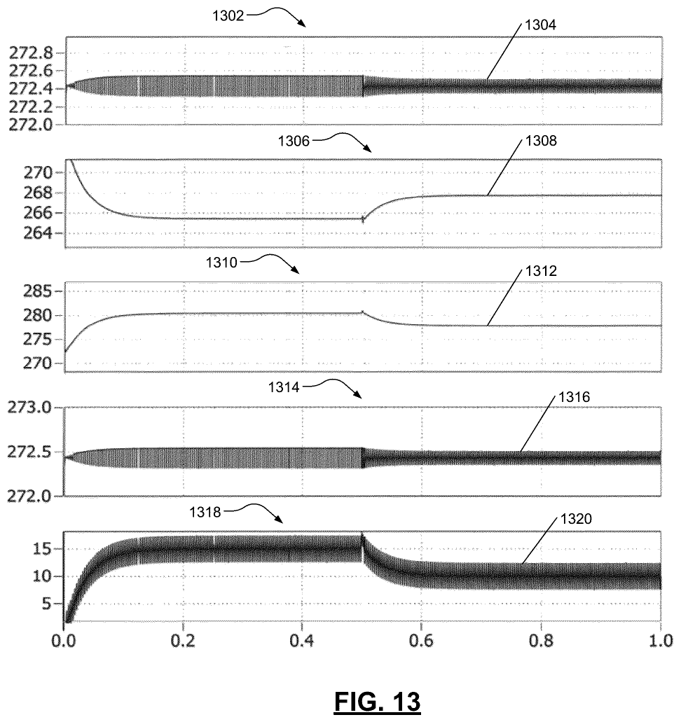

FIG. 12 depicts an example control circuit 1200 for the control module 550 of FIG. 5 for controlling the DC-DC converter 112 to balance the SOCs of the battery modules 102, 104. As shown, the control circuit 1200 of FIG. 12 includes SOC generators 1202, 1204, a voltage loop controller 1206, a target current generator 1208, a current loop controller 1210, a PWM generator 1212, and a filter 1214. Although the control circuit 1200 of FIG. 12 is described and shown as including specific components and functions, it should be appreciated that other suitable implementations may be employed to balance the SOCs of the battery modules 102, 104.

In the example of FIG. 12, the SOC generators 1202, 1204 calculate the SOCs of the battery modules 102, 104. This may be done based on the received voltage feedback signals 558, 562, as explained herein. Then, a voltage comparator 1216 compares the calculated SOCs of the battery modules 102, 104, and outputs a SOC error signal to the voltage loop controller 1206 based on the comparison. The voltage loop controller 1206 then generates and outputs a voltage signal based on the SOC error signal.

Then, the target current generator 1208 generates a commanded or target inductor current. More specifically, the target current generator 1208 receives the voltage signal from the voltage loop controller 1206 and generates a signal indicative of the target inductor current. A current comparator 1218 then compares the target inductor current and the sensed inductor current (obtained via the current feedback signal 554), and outputs a current error signal to the current loop controller 1210 based on the comparison. In various embodiments, the current feedback signal 554 may pass through the filter 1214 (e.g., a low-pass filter, etc.) before reaching the current comparator 1218, as shown in FIG. 6.

Next, the current loop controller 1210 generates and outputs a current signal based on the current error signal. In various embodiments, the current loop controller 1210 may be a proportional and integral (PI) controller or another suitable controller. The PWM generator 1212 then generates the control signals 564, 566 for the power switches 114, 116 based on the current signal from the current loop controller 1210.

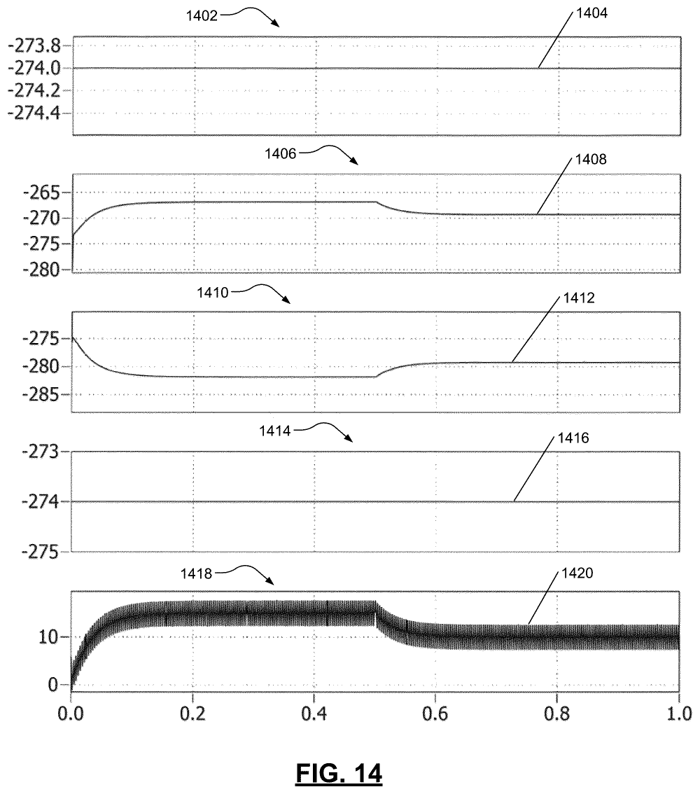

FIGS. 13-14 depict graphs representing various current characteristics of the power system 100 of FIG. 1 over time during discharging and charging modes. Specifically, graphs 1302, 1306, 1310, 1314, 1318 of FIG. 13 represent current values during a discharging mode, and graphs 1402, 1406, 1410, 1414, 1418 of FIG. 14 represent current values during a charging mode. In FIGS. 13-14, the graphs 1302, 1402 show the combined current 1304, 1404 of the battery modules 106, 108, the graphs 1306, 1406 show the current 1308, 1408 of the battery module 104, the graphs 1310, 1410 show the current 1312, 1412 of the battery module 102, the graphs 1314, 1414 show the load current 1316, 1416, and the graphs 1318, 1418 show the inductor current 1320, 1420. As shown in FIGS. 13-14, the inductor current 1320, 1420 is adjusted (e.g., controlled based on current of the power switches 114, 116), thereby causing the current 1308, 1408 of the battery module 104 and the current 1312, 1412 of the battery module 102 to change.

In various embodiments, any one of the power systems disclosed herein may be employable in any suitable vehicle, such as an EV (e.g., a pure electric vehicle, a plug-in hybrid electric vehicle, etc.). In other examples, the power systems disclosed herein may be implemented in other suitable non-vehicle applications including rechargeable battery modules having different capacities and/or chemical compositions.

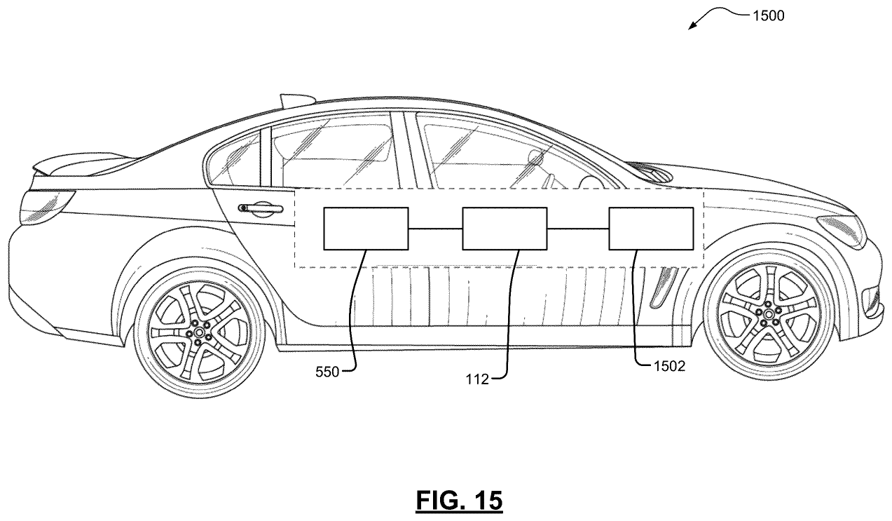

As one example, FIG. 15 depicts an EV 1500 including the control module 550 of FIG. 5, the DC-DC converter 112 of FIG. 1, and battery modules 1502 (e.g., representing the battery modules 102, 104 of FIG. 1 or 4). A load and a charging source may be coupled to the battery modules 1502, as explained herein.

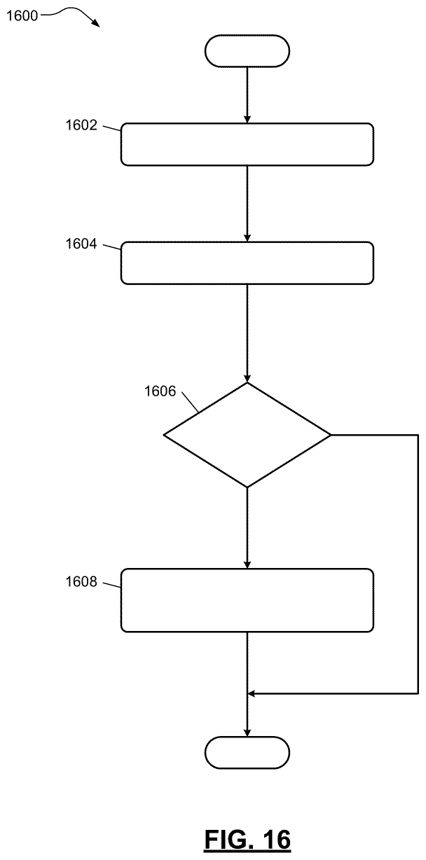

FIG. 16 illustrates an example control process 1600 employable by the power system 500 of FIG. 5 for balancing SOCs of the battery modules 102, 104. Although the example control process 1600 is described in relation to the power system 500 of FIG. 5 including the control module 550, the control process 1600 may be employable by another suitable power system and/or control module. Additionally, the power systems and the control modules herein, such as the power system 500 and the control module 550, should not be understood to be limited to the exemplary control process 1600.

As shown in FIG. 16, the process 1600 may begin at 1602 where the control module 550 senses parameters associated with the battery modules 102, 104. For example, and as explained above, the control module 550 may sense voltages of the battery modules 102, 104 via the voltage sensors 556, 560, respectively. Control then proceeds to 1604.

At 1604, the control module 550 calculates a SOC of each battery module 102, 104. For instance, the control module 550 may determine the SOC of each battery module 102, 104 based on the corresponding sensed battery module voltage and a known discharge curve for that battery module. Control then proceeds to 1606.

At 1606, the control module 550 determines whether the SOCs of the battery modules 102, 104 are balanced. For example, the control module 550 may compare the SOCs of the battery modules 102, 104 to determine if the SOCs are substantially the same (e.g., the same or within a nominal percent, such as plus/minus 0.5%, 1%, 2%, 3%, etc.). In other examples, the control module 550 may compare one or both SOCs of the battery modules 102, 104 to a target SOC to determine if the SOCs are substantially the same. In some examples, the target SOC may be set to a defined percentage achievable by both battery modules 102, 104 at the same time, set to one of the calculated SOCs of the battery modules 102, 104, etc. If the control module 550 determines that the SOCs of the battery modules 102, 104 are balanced at 1006, control may end as shown in FIG. 10 or return to another suitable step, such as 1002 if desired. If, however, the control module 550 determines that the SOCs of the battery modules 102, 104 are not balanced (e.g., the SOCs are different, one or both SOCs differs from the target SOC, etc.), control proceeds to 1608.

At 1608, the control module 550 generates and transmits control signals based on the sensed parameters for controlling the DC-DC converter 112. For example, and as explained above, the control module 550 may generate the control signals (e.g., PWM control signals) 564, 566 for controlling the power switches 114, 116 based on the sensed battery module voltages and/or one or more converter parameters, such as a sensed current flowing through the inductor 118. In such examples, the control module 550 may control one of the power switches 114, 116 to modulate and the other power switch 114, 116 to turn off depending on whether the power system 500 is operating in a discharging mode or a charging mode, as explained herein. In doing, one of the battery modules 102, 104 may discharge current to or receive current from the other battery module 102, 104 to balance the SOCs of the battery modules 102, 104. Control may end as shown in FIG. 16 or return to another suitable step, such as 1602 if desired.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

In this application, including the definitions below, the term “module” or the term “controller” may be replaced with the term “circuit.” The term “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components that provide the described functionality; or a combination of some or all of the above, such as in a system-on-chip.

The module may include one or more interface circuits. In some examples, the interface circuits may include wired or wireless interfaces that are connected to a local area network (LAN), the Internet, a wide area network (WAN), or combinations thereof. The functionality of any given module of the present disclosure may be distributed among multiple modules that are connected via interface circuits. For example, multiple modules may allow load balancing. In a further example, a server (also known as remote, or cloud) module may accomplish some functionality on behalf of a client module.

The term code, as used above, may include software, firmware, and/or microcode, and may refer to programs, routines, functions, classes, data structures, and/or objects. The term shared processor circuit encompasses a single processor circuit that executes some or all code from multiple modules. The term group processor circuit encompasses a processor circuit that, in combination with additional processor circuits, executes some or all code from one or more modules. References to multiple processor circuits encompass multiple processor circuits on discrete dies, multiple processor circuits on a single die, multiple cores of a single processor circuit, multiple threads of a single processor circuit, or a combination of the above. The term shared memory circuit encompasses a single memory circuit that stores some or all code from multiple modules. The term group memory circuit encompasses a memory circuit that, in combination with additional memories, stores some or all code from one or more modules.

The term memory circuit is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only memory circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general purpose computer to execute one or more particular functions embodied in computer programs. The functional blocks, flowchart components, and other elements described above serve as software specifications, which can be translated into the computer programs by the routine work of a skilled technician or programmer.

The computer programs include processor-executable instructions that are stored on at least one non-transitory, tangible computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

The computer programs may include: (i) descriptive text to be parsed, such as HTML (hypertext markup language), XML (extensible markup language), or JSON (JavaScript Object Notation) (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C #, Objective-C, Swift, Haskell, Go, SQL, R, Lisp, Java®, Fortran, Perl, Pascal, Curl, OCaml, JavaScript®, HTML5 (Hypertext Markup Language 5th revision), Ada, ASP (Active Server Pages), PHP (PHP: Hypertext Preprocessor), Scala, Eiffel, Smalltalk, Erlang, Ruby, Flash®, Visual Basic®, Lua, MATLAB, SIMULINK, and Python®.

What is claimed is:

1. A system for a vehicle, the system comprising:
a first battery module having a first capacity;
a second battery module having a second capacity different than the first capacity;
a DC-DC converter coupled to the first battery module and the second battery module; and
a control module coupled to the DC-DC converter, the control module configured to sense a first parameter associated with the first battery module and a second parameter associated with the second battery module, and control the DC-DC converter based on the first parameter and the second parameter to balance a state of charge of the first battery module and a state of charge of the second battery module.

2. The system of claim 1, wherein the DC-DC converter includes a first power switch coupled in parallel with the first battery module, a second power switch coupled in parallel with the second battery module, and an inductor coupled between the first and second power switches and the first and second battery modules.

3. The system of claim 2, wherein the control module is configured to:
sense a current flowing through the inductor; and
control the DC-DC converter based on the sensed current, the first parameter and the second parameter to balance the state of charge of the first battery module and the state of charge of the second battery module.

4. The system of claim 2, wherein the control module is configured to control a current flowing through the inductor to balance the state of charge of the first battery module and the state of charge of the second battery module.

5. The system of claim 4, wherein:
the first capacity of the first battery module is greater than the second capacity of the second battery module; and
the control module is configured to control the first power switch with a pulse width modulated control signal to discharge current from the first battery module to the second battery module via the inductor, when the control module is in a discharging mode in which the first battery module and the second battery module provide power a load.

6. The system of claim 4, wherein:
the first capacity of the first battery module is greater than the second capacity of the second battery module; and
the control module is configured to control the second power switch with a pulse width modulated control signal to discharge current from the second battery module to the first battery module via the inductor, when the control module is in a charging mode in which the first battery module and the second battery module are receiving power.

7. The system of claim 2, wherein the DC-DC converter includes a first capacitor coupled in parallel with the first power switch, and a second capacitor coupled in parallel with the second power switch.

8. The system of claim 1, wherein the first parameter is a voltage of the first battery module, and the second parameter is a voltage of the second battery module.

9. The system of claim 1, wherein:
the first battery module includes a plurality of cells;
the second battery module includes a plurality of cells; and
a chemical composition of at least one cell of the first battery module is different than a chemical composition of at least one cell of the second battery module.

10. The system of claim 9, wherein the at least one cell of the first battery module is a lithium-nickel-cobalt-manganese oxide (NMC) cell, and the at least one cell of the second battery module is a lithium ferrophosphate (LFP) cell.

11. The system of claim 1, wherein:
the first battery module includes N cells;
the second battery module includes M cells; and
N and M are integers greater than zero, and N is different than M.

12. The system of claim 1, wherein:
the first battery module includes a plurality of cells;
the second battery module includes a plurality of cells; and
at least one dimension of the first battery module is different than a corresponding dimension of the second battery module.

13. A vehicle comprising the system of claim 1 and at least one load coupled to the first battery module and the second battery module.

14. A method of controlling a DC-DC converter in a vehicle to balance a state of charge of a first battery module and a state of charge of a second battery module, the DC-DC converter including a first power switch coupled in parallel with the first battery module, a second power switch coupled in parallel with the second battery module, and an inductor coupled between the first and second power switches and the first and second battery modules, the first battery module having a first capacity, the second battery module having a second capacity different than the first capacity, the method comprising:
sensing at least one first parameter associated with the first battery module and at least one second parameter associated with the second battery module; and
controlling the first power switch or the second power switch based on the first parameter and the second parameter to balance the state of charge of the first battery module and the state of charge of the second battery module.

15. The method of claim 14, wherein:
the first capacity of the first battery module is greater than the second capacity of the second battery module; and
controlling the first power switch or the second power switch includes controlling the first power switch with a pulse width modulated control signal to discharge current from the first battery module to the second battery module via the inductor, when the first battery module and the second battery module are providing power a load.

16. The method of claim 14, wherein:
the first capacity of the first battery module is greater than the second capacity of the second battery module; and
controlling the first power switch or the second power switch includes controlling the second power switch with a pulse width modulated control signal to discharge current from the second battery module to the first battery module via the inductor, when the first battery module and the second battery module are receiving power.

17. The method of claim 14, wherein:
the first battery module includes a plurality of cells;
the second battery module includes a plurality of cells; and
a chemical composition of at least one cell of the first battery module is different than a chemical composition of at least one cell of the second battery module.

18. The method of claim 17, wherein the at least one cell of the first battery module is a lithium-nickel-cobalt-manganese oxide (NMC) cell, and the at least one cell of the second battery module is a lithium ferrophosphate (LFP) cell.

19. The method of claim 14, wherein:
the first battery module includes N cells;
the second battery module includes M cells; and
N and M are integers greater than zero, and N is different than M.

20. The method of claim 14, wherein:
the first battery module includes a plurality of cells;
the second battery module includes a plurality of cells; and
at least one dimension of the first battery module is different than a corresponding dimension of the second battery module.
